(19) United States
(12) Patent Application Publication
(10) Pub. No.: US 2014/0134216 A1
(43) Pub. Date: May 15, 2014

(54) IRON OXIDE RED PIGMENT

(71) Applicant: National University Corporation Okayama University, (US)

(72) Inventors: Jun TAKADA, Okayama (JP); Hideki HASHIMOTO, Okayama (JP); Tatsuo FUJII, Okayama (JP); Makoto NAKANISHI, Okayama (JP)

(73) Assignee: NATIONAL UNIVERSITY CORPORATION OKAYAMA UNIVERSITY, Okayama (JP)

(21) Appl. No.: 13/676,456

(22) Filed: Nov. 14, 2012

(51) Int. Cl. C08K 3/22

(52) U.S. Cl. CPC C08K 3/22
USPC 424/401; 106/457; 424/63; 424/70.6; 424/64; 424/61

(57) ABSTRACT

Disclosed are a hematite composite formed by aggregation of fine particles, each of the fine particles comprising a crystalline hematite particle and phosphorus-containing amorphous silicate covering the surface of the crystalline hematite particle; a pigment comprising the hematite composite; a cosmetic composition comprising a cosmetic pigment containing the hematite composite and a cosmetic base; and a method for producing the hematite composite, comprising the step of heat-treating an amorphous and/or microcrystalline iron oxide containing silicon and phosphorus.

### TECHNICAL FIELD

The present invention relates to a hematite composite with a novel color tone, a pigment containing the hematite composite; a cosmetic composition containing the hematite composite; and a production method of the hematite composite.

### BACKGROUND ART

α-Fe₂O₃ (hematite) is of significant interest to nanoscience and nanotechnology researchers because of its potential for application in pigments; as gas-sensing materials; as catalysts; and as positive and negative electrodes of lithium-ion batteries. In view of such significant applications, in recent years, many methods for producing hematite nanoparticles have been reported, such as the hydrolysis of an Fe (III) solution; thermal decomposition; sol-gel methods; microemulsion methods; and the like. These methods are capable of controlling the particle size, size distribution, dispersibility, and morphology of the nanoparticles.

Because of its beautiful red color, hematite powder is widely used as a pigment for overglaze enamels on porcelain. The expression “beautiful red color” used herein means that the color has high L*, a*, and b* values (in particular, exhibits high a* and b* values denoting red and yellow colors) on a CIE 1976 L*a*b* color space (Y. Ohno, Paper for IS&T NIP16 Conference, Canada, Oct. 16-20 (2000), 1-6). In Japan, vivid red hematite has been used in an elegant enamel-decoration technique called aka-e (a kind of red color used in the technique of touching up dyed figures on porcelain), commonly performed on Kakiemon-style wares. Kakiemon-style wares enthralled royalty and aristocrats when it was exported to Europe in the 17th and 18th centuries.

In general, hematite red color increases in beauty as its particle size decreases. When hematite is used in aka-e, the overglaze enamel is prepared by mixing hematite powder with appropriate glazes, drawing with this mixture on porcelain, and then heat-treating the porcelain at a high temperature (700 to 800° C.). During the heat treatment, the color of hematite fades when hematite grain growth occurs. Therefore, it is highly desirable for hematite powder to be thermostable and not be susceptible to grain growth during heat treatment at a high temperature. Hematite has been produced from natural minerals or has been industrially synthesized; however, the need for the development of a new red pigment with a vivid red color and heat resistance is increasing.

In natural aquatic environments, iron-oxidizing bacteria gain energy for survival by oxidizing Fe²⁺ to Fe³⁺, thereby extracellularly forming micrometer-scale iron oxides of tubular or helical shapes. They are visible everywhere, for example, in side ditch, canal irrigation, small stream, or hydrothermal deposit, as ocher precipitates that have until now been regarded as useless substances. Hereunder, the present inventors collectively refer to the iron-containing precipitates formed by iron-oxidizing bacteria as biogenous iron oxide (BIOX). To date, most relevant BIOX studies have been conducted from microbiological and geochemical perspectives. However, the present inventors conducted studies from a materials-science perspective.

Examples of BIOX include BIOX microtubule (L-BIOX) formed by genus Leptothrix (S. Spring, The Genera Leptothrix and Sphaerotilus, in: M. Dworkin, S. Falkow, E. Rosenberg, K. H. Schleifer, E. Stackebrandt (Eds.) The Prokaryotes, Springer, New York, 2006, pp. 758-777) and helical BIOX (G-BIOX) formed by genus Gallionella (H. H. Hanert, The Genus Gallionella, in: M. Dworkin, S. Falkow, E. Rosenberg, K. H. Schleifer, E. Stackebrandt (Eds.) The Prokaryotes, Springer, New York, 2006, pp. 990-995).

In the past, reports suggesting the use of iron oxide tubes formed by iron-oxidizing bacteria in the Jomon and Yayoi periods as a material of red pigments have been published in the field of archaeology (Non-Patent Documents 1-3). Moreover, there have been attempts to reproduce the red powder from those periods by heating precipitates containing iron oxides presumably formed by iron-oxidizing bacteria. However, the powder produced by this method has very low a*, b* values, and its heat resistance has not been confirmed (Non-Patent Document 3). Moreover, the sample contained many components other than hematite.

### PRIOR ART DOCUMENTS

### Non-Patent Document

[Non-Patent Document 1] “Nihon bunkazai kagakukai dai14kai taikai kenkyu happyo yoshishu [Summary of research presentation in 14th meeting of Japan Society for Scientific Studies on Cultural Properties]” Fumio OKADA, (1997) 38-39.
[Non-Patent Document 2] “Nihon bunkazai kagakukai dai14kai taikai kenkyu happyo yoshishu [Summary of research presentation in 14th meeting of Japan Society for Scientific Studies on Cultural Properties]” Junko FURIHATA, Masaaki SAWADA, (1997) 76-77.
[Non-Patent Document 3] N. Kitano, Archaeology and Natural Science, 56 (2007) 41-63.

### Summary of Invention

### Problem to be Solved by the Invention

An object of the present invention is to provide a hematite composite that has a vivid red color and that is not susceptible to grain growth during heat treatment at a high temperature, i.e., that does not fade in color; a pigment containing the hematite composite; and a cosmetic composition containing the hematite composite.

### Means for Solving the Problem

The present inventors found that when tubular or helical BIOX containing Si and P in its structure is highly purified (removal of ions contained in groundwater and removal of a sand component from groundwater or from soil) and heated as a starting material, Fe, Si, and P are phase-separated in the process of the heating, and the Fe component forms into iron oxide and the Si and P components form into amorphous phase; as a result, the size of hematite particles is decreased and the amorphous phase is present in such a way that the hematite particles are covered with the amorphous phase, thus obtaining a vivid red powder. Further, since this red powder undergoes heat treatment at a high temperature of 700 to 900° C., it has high heat resistance.

The present invention has been accomplished based on these findings and further research. The present invention provides the following hematite composite, pigment, cosmetic composition, and method for producing the hematite composite.

Item 1. A hematite composite formed by aggregation of fine particles, each of the fine particles comprising a crystalline hematite particle and phosphorus-containing amorphous silicate covering the surface of the crystalline hematite particle.
Item 2. The hematite composite according to Item 1, which is hollow or helical.
Item 3. The hematite composite according to Item 1, wherein the crystalline hematite particle contains silicon and phosphorus.
Item 4. The hematite composite according to Item 3, wherein the content (atomic ratio) of silicon and phosphorus in the crystalline hematite particle is less than the content (atomic ratio) of silicon and phosphorus in the amorphous silicate.
Item 5. The hematite composite according to Item 1, which has a red color value a* (reddish) of 25 or more.
Item 6. The hematite composite according to Item 1, which has a yellow color value b* (yellowish) of 30 or more.
Item 7. A pigment comprising the hematite composite according to Item 1.
Item 8. The pigment according to Item 7, which is for use in ceramics, paints for art, coatings, inks, or cosmetics.
Item 9. A cosmetic composition comprising a cosmetic pigment containing the hematite composite according to Item 1 and a cosmetic base.
Item 10. A method for producing the hematite composite according to Item 1, comprising the step of heat-treating an amorphous and/or microcrystalline iron oxide containing silicon and phosphorus.
Item 11. The method according to Item 10, wherein the heat treatment is conducted at a temperature of 700 to 1000° C.
Item 12. The method according to Item 10, wherein the heat treatment is conducted at a temperature of 750 to 900° C.
Item 13. The method according to Item 10, wherein the iron oxide contains iron and oxygen as main components, and the element ratio of iron, silicon, and phosphorus, excluding oxygen, is 66 to 87:2 to 27:1 to 32 in terms of atomic %, the atomic % of iron, silicon and phosphorus summing up to 100.
Item 14. The method according to Item 10, wherein the iron oxide contains 0.1 to 5 weight % of carbon.
Item 15. The method according to Item 10, wherein the microcrystalline iron oxide is ferrihydrite and/or lepidocrocite.
Item 16. The method according to Item 10, wherein the iron oxide is an iron oxide produced by an iron-oxidizing bacterium.
Item 17. The method according to Item 10, wherein the iron oxide is an iron oxide separated from aggregated precipitates produced in a water purification method by iron bacteria.
Item 18. The method according to Item 16, wherein the iron-oxidizing bacterium belongs to the genus Leptothrix and/or the genus Gallionella.
Item 19. The method according to Item 16, wherein the iron-oxidizing bacterium is Leptothrix cholodnii OUMS1 (NITE SP-860).
Item 20. The method according to Item 10, wherein the iron oxide is microcrystalline.

### Effect of the Invention

In the present invention, a hematite composite with a novel color tone was produced using an iron-oxidizing bacterium-derived iron oxide as a starting material. The hematite composite of the present invention exhibits high a* and b* values, in particular, exhibits a higher b* value than that of hitherto known hematite red powder, and has a novel color tone. Further, the hematite composite of the present invention has higher heat resistance (property that during heat treatment, grain growth of hematite particles does not occurs, and there is no color change) than hitherto known hematite. In addition, since the hematite composite of the present invention is an aggregate of fine particles and has a higher-order structure such as a tubular shape or helical shape, it is believed that the hematite composite of the present invention is excellent in oil absorption property and water absorption property. From such features, it is believed that the hematite composite of the present invention can be used as a cosmetic pigment or as a pigment for ceramics.

### BRIEF DESCRIPTION OF DRAWINGS

FIG. 1 shows electron micrographs of the starting materials. a) L-BIOX-1, b) L-BIOX-2, c) G-BIOX

FIG. 2 is a graph showing XRD patterns of heat-treated L-BIOX-1 samples. They are (from bottom) the unheated sample, the sample heat-treated at 600° C., the sample heat-treated at 700° C., the sample heat-treated at 800° C., the sample heat-treated at 900° C., the sample heat-treated at 1000° C., and the sample heat-treated at 1100° C.

FIG. 3 (a) is a graph showing reflectance curves of the L-BIOX-1 sample heat-treated at 800° C. (L-800), the sample obtained by reheating L-800 at 800° C. (Re-L-800), commercially available hematite (MC-55), and the sample obtained by heating MC-55 at 800° C. (Re-MC-55). FIG. 3 (b) is a graph showing L*, a*, and b* values of L-800, Re-L-800, MC-55, and Re-MC-55.

FIG. 4 shows TEM images of (a, c) L-BIOX and (b, d) L-800. The inset images in (a) and (b) are electron diffraction patterns. The inset in (d) is the enlarged image of the white square area, and the straight lines show the (012) plane of hematite. The wavy line shows the boundary between hematite and amorphous silicate.

FIG. 5 shows STEM/EDS analysis results of L-800. The left image is a secondary electron image measured by STEM. The enlarged image of the white square area in the left image is, among the six images on the right side, the leftmost image on the top row. The other five images are elemental mapping images of Fe, O, Si, and P, and an overlay of images of Fe, Si, and P.

FIG. 6 is a graph showing color measurement results (a* and b* values) of the heat-treated samples of L-BIOX-1.

FIG. 7 shows STEM/EDS mapping images of the heat-treated samples of L-BIOX-1. The top-row images show secondary electron images measured by STEM. The bottom-row images show overlays of mapping images of Fe and Si.

FIG. 8 is a graph showing XRD patterns of heat-treated L-BIOX-2 samples. They are (from bottom) the unheated sample, the sample heat-treated at 750° C., the sample heat-treated at 800° C., and the sample heat-treated at 850° C.

FIG. 9 is a graph showing color measurement results (a* and b* values) of the heat-treated samples of L-BIOX-2.

FIG. 10 shows TEM images of the L-BIOX-2 sample heat-treated at 800° C. The left image shows a low-magnification image, and the right image shows a high-magnification image. The inset in the right image is an enlarged image of the white square area, and the straight lines show the (012) plane of hematite. The wavy line shows the boundary between hematite and amorphous silicate.

FIG. 11 is a graph showing XRD patterns of heat-treated G-BIOX samples. They are (from bottom) the unheated sample, the sample heat-treated at 600° C., the sample heat-treated at 700° C., the sample heat-treated at 800° C., the sample heat-treated at 900° C., and the sample heat-treated at 1000° C.

FIG. 12 is a graph showing color measurement results (a* and b* values) of the heat-treated samples of G-BIOX.

FIG. 13 shows TEM images of the G-BIOX sample heat-treated at 800° C. The left image shows a low-magnification image, and the right image shows a high-magnification image. The inset in the right image is an enlarged image of the white square area, and the straight lines show the (006) plane of hematite. The wavy line shows the boundary between hematite and amorphous silicate.

### MODE FOR CARRYING OUT THE INVENTION

The present invention is described in detail below.

The hematite composite of the present invention is formed by aggregation of fine particles, each of the fine particles comprising a crystalline hematite particle and phosphorus-containing amorphous silicate covering the crystalline hematite particle.

Further, the hematite composite of the present invention is preferably formed by aggregation of fine particles, each of the fine particles comprising a core including a crystalline hematite particle and a shell including phosphorus-containing amorphous silicate.

The crystalline hematite (α-Fe₂O₃) particle has a mean particle diameter of typically about 10 to 350 nm, and preferably about 40 to 200 nm. In addition, it is desirable that the crystalline hematite particle (core) contains silicon and phosphorus.

The amorphous silicate (shell) covers the crystalline hematite particle. Here, the term “cover” means that the amorphous silicate at least partially covers the crystalline hematite particle, and encompasses the case where the amorphous silicate covers all of the crystalline hematite particle; and the case where the amorphous silicate covers part of the crystalline hematite particle, and part of the crystalline hematite particle is exposed.

The thickness of the amorphous silicate phase is typically about 1 to 100 nm, and preferably about 10 to 50 nm. The amorphous silicate contains phosphorus and it is desirable that the content (atomic ratio) of silicon and phosphorus in the crystalline hematite particle is less than the content (atomic ratio) of silicon and phosphorus in the amorphous silicate. Here, silicon and phosphorus in the crystalline hematite particle typically form silicon oxide and phosphorus oxide, and phosphorus in the amorphous silicate also typically forms phosphorus oxide.

The fine particles each comprise the crystalline hematite particle and the amorphous silicate; and have a mean particle diameter of typically about 11 to 450 nm, and preferably about 20 to 250 nm.

The hematite composite of the present invention is formed by aggregation of the fine particles, and is preferably hollow or helical. The hollow hematite composite typically has a diameter of about 0.7 to 1.4 μm, and a length of about 5 to 500 μm. The helical hematite composite typically has a width of about 0.5 to 1.5 μm, and a length of about 3 to 400 μm.

Regarding the color of the hematite composite of the present invention, L* (lightness) is preferably 30 to 55, and more preferably 35 to 50; a* (reddish) is preferably 25 or more, and more preferably 25 to 50; and b* (yellowish) is preferably 30 or more, and more preferably 30 to 50. The parameters L*, a*, and b* are defined in a color space called the CIE 1976 L*a*b* color system, recommended by the International Commission on Illumination (CIE) in 1976, and can be measured by the method disclosed in the Examples. The color of the hematite composite of the present invention by visual observation is bright yellowish red.

Since the hematite composite of the present invention exhibits high a* and b* values, and, in particular, has a b* value higher than that of hitherto known red hematite powder, it has a novel color hue and tone. Therefore, the hematite composite of the present invention can be suitably used as a pigment. Examples of the pigment include pigments for ceramics, pigments for paints for art, pigments for coatings, pigments for inks, pigments for cosmetics, and the like.

The pigment of the present invention may contain only the above-described hematite composite, or may contain not only the above-described hematite composite, but also a known compounding agent, etc., used for pigments. The compounding agent can be suitably selected according to the intended use of the pigment (for ceramics, for paints for art, for coatings, for inks, for cosmetics, or the like).

The cosmetic composition of the present invention comprises a cosmetic pigment containing the hematite composite, and a cosmetic base.

The cosmetic composition of the present invention encompasses any cosmetic composition applied to the skin, mucous membranes, body hair, head hair, scalp, nails, teeth, facial skin, lips, etc., of animals (including humans).

The content of the cosmetic pigment in the cosmetic composition of the present invention can be suitably selected, as the content of the hematite composite, from the range of preferably 0.01 to 100 weight %, and more preferably 0.1 to 100 weight %.

Examples of the cosmetic base include whitening agents, humectants, antioxidants, oily components, UV absorbers, surfactants, thickeners, alcohols, powdery components, coloring materials, film-forming polymers, plasticizers, volatile solvents, gelling agents, aqueous components, water, various skin nutrients, and the like. Appropriate cosmetic bases are blended as required.

The cosmetic composition of the present invention may take a broad range of forms such as solubilization types, aqueous solution types, powder types, emulsion types, oily liquid types, gel types, aerosol types, ointment types, water-oil two-layer types, and water-oil-powder three-layer types.

The cosmetic composition of the present invention is used in any application, for example, including basic skin care cosmetics such as facial washes, lotions, emulsions, essences, packs, creams, serums, gels, and masks; makeup cosmetics such as lipsticks, foundations, eyeliners, blushes, eye shadows, and mascaras; nail cosmetics such as nail polish, topcoats, basecoats, and nail polish removers; and other applications such as agents for massage, facial washes, cleansing agents, preshave lotions, aftershave lotions, shaving creams, body soaps, soaps, shampoos, conditioners, hair treatments, hairdressings, hair growth stimulants, hair tonics, semi-permanent hair dyes, hair colorants, antiperspirants, and bath additives.

The hematite composite of the present invention can be produced by a production method comprising the step of heat-treating an amorphous and/or microcrystalline iron oxide containing silicon and phosphorus.

The temperature of the heat treatment is preferably 700 to 1000° C., and more preferably 750 to 900° C. The heat treatment time is preferably 0.1 to 200 hours, and preferably 2 to 120 hours. When the temperature of the heat treatment and the heat treatment time are within the above ranges, high a* and b* values can be obtained. The heat treatment is typically conducted in atmospheric air. By controlling the temperature of the heat treatment and the heat treatment time, desired a* and b* values can be obtained. In this manner, the hematite composite of the present invention undergoes heat treatment at a high temperature at the time of production. Thus, the hematite composite of the present invention has a feature such that even when it is reheated, grain growth of hematite particles does not occur, and there is nearly no fading of color.

It is desirable that, prior to the heat treatment step, a collected iron oxide is subjected to the steps of pure water replacement (for removing cations and anions contained in groundwater), washing (for removing sand and the like derived from groundwater), and drying.

In the present specification, “iron oxide” is a generic term for compounds that contain iron and oxygen as main components. These compounds include iron oxides in a narrow sense, such as α-Fe₂O₃, β-Fe₂O₃, γ-Fe₂O₃, and Fe₃O₄; iron oxyhydroxides, such as α-FeOOH, β-FeOOH, and γ-FeOOH; and iron hydroxides with a structure close to an amorphous structure, such as ferrihydrite.

It is preferable that the iron oxide contains iron and oxygen as main components and that the element ratio of iron, silicon, and phosphorus, excluding oxygen, is 66 to 87:2 to 27:1 to 32 (in particular, 70 to 77:16 to 27:1 to 9), in terms of atomic % (the atomic % of iron, silicon and phosphorus sum up to 100). Further, it is also preferable that the iron oxide contains 0.1 to 5 weight %, and in particular 0.5 to 2 weight %, of carbon.

The iron oxide is amorphous or microcrystalline. Examples of the microcrystalline iron oxide include ferrihydrite, lepidocrocite, and the like. It is desirable that the microcrystalline iron oxide contains 5 to 20 weight %, and in particular 7 to 15 weight %, of carbon.

The iron oxide is preferably produced by an iron-oxidizing bacterium. The iron-oxidizing bacterium is not particularly limited, as long as it forms an amorphous or microcrystalline iron oxide containing silicon and phosphorus. Examples of iron-oxidizing bacteria include Toxothrix sp., Leptothrix sp., Crenothrix sp., Clonothrix sp., Gallionella sp., Siderocapsa sp., Siderococcus sp., Sideromonas sp., Planctomyces sp., and the like.

Leptothrix ochracea, a Leptothrix sp. bacterium, can produce BIOX with a hollow fibrous sheath structure. Further, Gallionella ferruginea, a Gallionella sp. bacterium, can produce helical BIOX.

A Leptothrix cholodnii OUMS1 strain is one example of Leptothrix sp. bacteria. The Leptothrix cholodnii OUMS1 strain was deposited as Accession No. NITE P-860 in the National Institute of Technology and Evaluation, Patent Microorganisms Depositary (Kazusa Kamatari 2-5-8, Kisarazu, Chiba, 292-0818, Japan) on Dec. 25, 2009. This bacterial strain has been transferred to an international deposit under Accession No. NITE BP-860.

There is no particular limitation to the method for obtaining BIOX, and various methods can be used. For example, a method for obtaining BIOX from aggregated precipitates produced in a biological water purification method (water purification method by iron bacteria) or produced by iron-oxidizing bacteria present in a water purification plant (for example, JP2005-272251A); the method disclosed in JP10-338526A, which is for producing pipe-shaped particulate iron oxides; or other methods can be used as the method for obtaining BIOX. For the explanations of these methods, the disclosures of these documents are incorporated herein by reference.

Although the structure of BIOX produced by an iron-oxidizing bacterium varies depending on the iron-oxidizing bacterium used for the production and the conditions during the production, BIOX having a hollow fibrous sheath structure, a helical shape, a grain shape, or a thread shape is included. For example, depending on water purification plants from which sludge is obtained, BIOX with a hollow fibrous sheath structure may be mainly included, or grain-shaped BIOX may be mainly included.

However, any iron oxide may be used in the present invention, regardless of whether it has any shape of the above hollow fibrous sheath structure, helical shape, grain shape and thread shape, or a combination of any two or more thereof, as long as it is produced by an iron-oxidizing bacterium and is an amorphous or microcrystalline iron oxide containing silicon and phosphorus.

Regarding the constituent elements of BIOX, BIOX contains iron and oxygen as main components, and further contains silicon, phosphorus, etc. This composition suitably varies depending on the environment in which iron-oxidizing bacteria exist, and the like. Thus, BIOX is different in terms of composition from synthesized iron oxides, such as 2-line ferrihydrite, which do not contain phosphorus or silicon. Further, measurement results of samples by SEM reveal that each constituent element is uniformly distributed in BIOX.

### Examples

Examples are given below to illustrate the present invention in more detail. However, the present invention is not limited to these Examples.

### [Purification of BIOX]

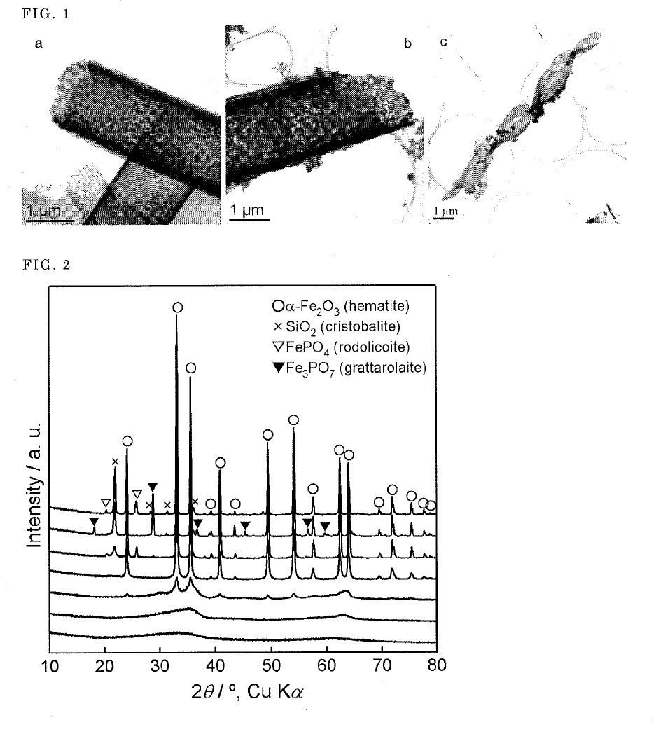

Groundwater slurry containing BIOX was collected from a culture tank for iron-oxidizing bacteria (sampling site 1) installed in Joyo City Cultural Center, a public facility in Joyo-shi, Kyoto. The predominant species in this culture tank was Leptothrix ochracea, an iron-oxidizing bacterium; and the obtained BIOX was tubular, with a diameter of about 1 μm (FIG. 1a) [1]. This tubular structure was formed by aggregation of primary particles with a diameter of 3 nm into secondary (fibrous or spherical) structures with a diameter of several tens of nanometers, which were further aggregated into a tube. Many of the tubes had a fibrous surface structure and a spherical inner structure [2]. When the slurry was allowed to stand for several days, BIOX sank to the bottom of the container. To remove the cations (e.g., Na⁺, Ca²⁺) and anions (e.g., NO³⁻, SO₄²⁻) contained in the groundwater, the supernatant was removed by decantation, and distilled water was added. This operation was repeated until the electric conductivity of the supernatant became 10 μS/cm or less. Subsequently, a 28% aqueous NH₃ solution was added to the slurry to adjust the pH to 10.5, and the mixture was stirred for 10 minutes. After the stirring was stopped, the resulting mixture was allowed to stand for 40 minutes. With this operation, sands and the like derived from the groundwater and contained in the slurry sank to the bottom, and BIOX was highly dispersed. Only the supernatant was filtered by decantation, and washed with a 4-fold amount of distilled water. The obtained wet cake was dispersed in ethanol, and stirred for 15 minutes. The suspension was filtrated through a filter, and dried at 100° C. The obtained powder was used as a starting material (L-BIOX-1). Composition analysis by energy-dispersive X-ray spectroscopy (EDS; “Genesis 2000,” produced by EDAX) confirmed that the composition of L-BIOX-1 was Fe:S:P=73:22:5 [2].

Groundwater slurry containing BIOX was collected from a culture tank for iron-oxidizing bacteria (sampling site 2) installed on the agricultural land of the Faculty of Agriculture of Okayama University, and purified and dried in the same manner as above (L-BIOX-2). The composition analysis by EDS confirmed that the composition of L-BIOX-2 was Fe:Si:P=78:10:12 [2]. L-BIOX-2 was larger than L-BIOX-1 in the size of secondary particles constituting the tubular walls or tubes, but was similar to L-BIOX-1 in terms of macro-morphology, size, primary particle size and the like (FIG. 1b).

Groundwater slurry containing BIOX was collected from another culture tank for iron-oxidizing bacteria (sampling site 3) installed on the agricultural land of the Faculty of Agriculture of Okayama University. The dominant species in this culture tank was Gallionella ferruginea, an iron-oxidizing bacterium; and the obtained BIOX was helical, with a width of about 1 pan. This helical configuration consists of 3 nm primary particles aggregated into string-like structures, which are further aggregated into a bundle of strings, and twisted (FIG. 1c). When the slurry was allowed to stand for several days, BIOX sank to the bottom of the container. To remove cations (e.g., Na⁺, Ca²⁺) and anions (e.g., NO³⁻, SO₄²⁻) contained in the groundwater, the supernatant was removed by decantation, and distilled water was added. This operation was repeated until the electric conductivity of the supernatant became 10 μS/cm or less. The precipitate from which the supernatant had been removed was dried with a freeze-dryer, and used as a starting material (G-BIOX). The composition analysis by EDS confirmed that the composition of G-BIOX was Fe:Si:P=79:16:5 [3].

The results of X-ray diffraction (XRD; “RINT2000,” produced by Rigaku) and measurements using a transmission electron microscope (TEM, “JEM-2100F,” produced by JEOL) indicated that all of the samples were amorphous, and that primary particles had a diameter of 3 nm.

### [Heat-Treatment of BIOX]

300 mg of BIOX purified by the above method was weighed into a crucible and heated in atmospheric air in a muffle furnace for 2 hours. The temperature was raised at a rate of 10° C./min, and cooling was performed by furnace cooling. The obtained powder (heat-treated sample) was evaluated by XRD, TEM, EDS, and a spectrophotometer. A commercially available hematite (“MC-55”, produced by Morishita Bengara Kogyo Co., Ltd.) was used as a comparative color sample. To investigate the heat resistance of the powder, a sample heat-treated at 800° C. (L-BIOX-1) and MC-55 were calcined in atmospheric air at 800° C. for 1 hour, and color measurement was performed.

For the color measurement, a “CM-2600d” spectrophotometer produced by Konica Minolta Sensing, Inc. was used. In the measurement, a standard white plate (produced by National Physical Laboratory) was used as a color calibration sample. A D65 light source was used as a measurement light source, and a wavelength calibration filter (produced by National Institute of Standards and Technology) was used for wavelength calibration. A groove formed in a glass plate to have a diameter of 8 mm and a depth of 0.2 mm was evenly filled with the powder sample so as to minimize color variation, and L*, a*, and b* values were measured with a spectrophotometer.

### [Evaluation of the Heat-Treated L-BIOX-1 Sample]

FIG. 2 shows XRD patterns of the heat-treated L-BIOX-1 samples. The heat-treated samples turned brown (600° C., 700° C.), reddish yellow (800° C.), wine red (900° C.), purple (1000° C.), and finally deep purple (1100° C.). Although the color change from yellow to red due to transformation of goethite (common iron hydroxide, α-FeOOH) into hematite is well known, iron oxide that exhibits such varied color changes is rare. Such changes in color are considered to be attributable to the difficulty of phase transformation to hematite. Pure iron hydroxide usually dehydrates and transforms into hematite at about 300° C. In contrast, L-BIOX substantially does not undergo a phase transformation until reaching 600° C., slightly crystallizes to hematite at 700° C., and transforms to monophasic hematite (radiographically) at 800° C. It has been confirmed that L-BIOX contains Si and P in its structure; and that the composition of L-BIOX is Fe:S:P=73:22:5, and does not change when heat-treated in atmospheric air. The difficulty of phase transformation to hematite is presumably because Si and P contained in L-BIOX-1 inhibit the rearrangement of atoms. When the heating temperature is further increased, crystalline silica (cristobalite) and crystalline iron phosphates (FePO₄ and Fe₃PO₇) are formed at 900° C. or more. The peaks of hematite sharpen with increasing temperature, indicating that crystal growth occurs.

Here, we focused on the sample heat-treated at 800° C. (L-800) that is radiographically monophasic hematite with the brightest strongly reddish and yellowish color; and the crystalline structure, color, and microstructure of L-800 were investigated in detail. Although L-800 is radiographically monophasic hematite, the lattice constants of L-800 are a=0.5039 nm and c=1.3767 nm, which are slightly longer than those of pure hematite. Campbell et al. reported that the water and/or Si contained in the hematite structure decreases Fe occupancy, thus changing the hematite lattice constants [4]. Galvez et al. prepared hematite containing P in the structure and reported that the c-axis length increases with increasing P content, and that P occupies tetrahedral interstices in the hematite structure [5]. It is considered from such backgrounds and the above results that the lattice constants of L-800 are long due to trace amounts of Si and P that are in solid solution in the hematite structure. It is assumed that these are located randomly at some tetrahedral interstices of oxygen packing.

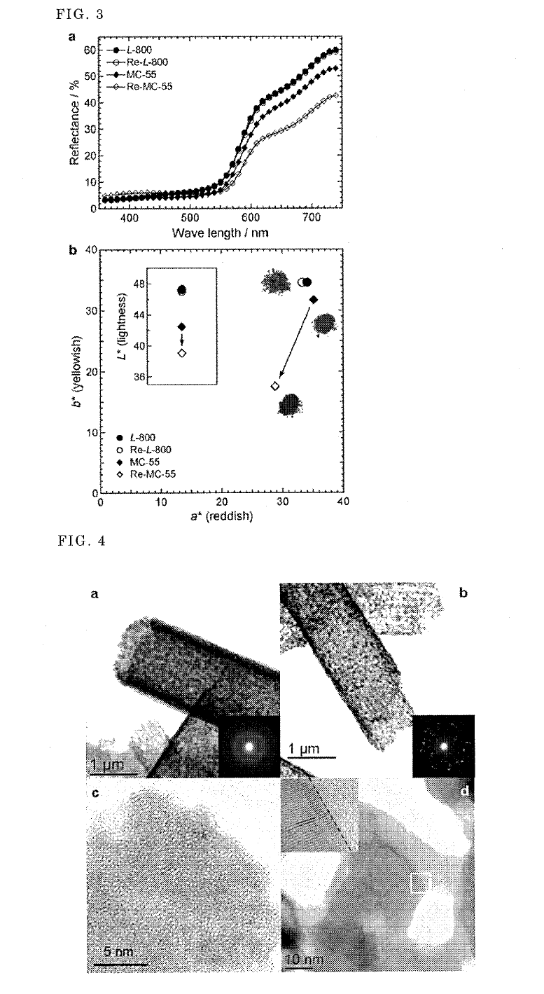

FIG. 3 shows the color measurement results of L-800, commercially available MC-55 (particle size: about 100 nm), and heat-treated L-800 and MC-55 samples (Re-L-800 and Re-MC-55), both being heat-treated in atmospheric air at 800° C. for 1 hour. The reflectance edge of all of the samples was in the same position, near 585 nm, but reflectance intensities beyond 450 nm decreased in the following order: L-800≈Re-L-800>MC-55>Re-MC-55 (FIG. 3a). FIG. 3b shows the CIE parameters L* (lightness), a* (reddish) and b* (yellowish), calculated from reflectance curves. The results indicate that although MC-55 had the highest a* value (35.2), L-800 had very beautiful color, with the values L*=47.3, a*=34.1 and b*=34.6; and had particularly high b* and L* values. That is, L-800 was a beautiful bright yellowish red powder. Furthermore, the L*, a*, and b* values for Re-L-800 were almost equal to those for L-800, while Re-MC-55 showed significant color fading, with the values L*=39.1, a*=28.8, b*=17.5 (FIG. 3b). These results indicate that L-800 is a thermostable hematite powder with high CIE parameter values. In general, the color of hematite depends on its particle diameter and aggregation state. Specifically, when the particle diameter and the size of aggregated particles are small, hematite has a vivid red color; and, as the particle diameter and the size of aggregated particles become large, hematite tends to have a black color [6, 7]. Accordingly, Re-MC-55 seemed to have undergone grain growth, and had a large particle size, while Re-L-800 did not seem to have undergone grain growth. In fact, Re-MC-55 had a particle diameter of about 200 nm, which was about twice that of MC-55 (measured by SEM); whereas Re-L-800 had exactly the same particle diameter and particle shape as those of L-800 (measured by TEM).

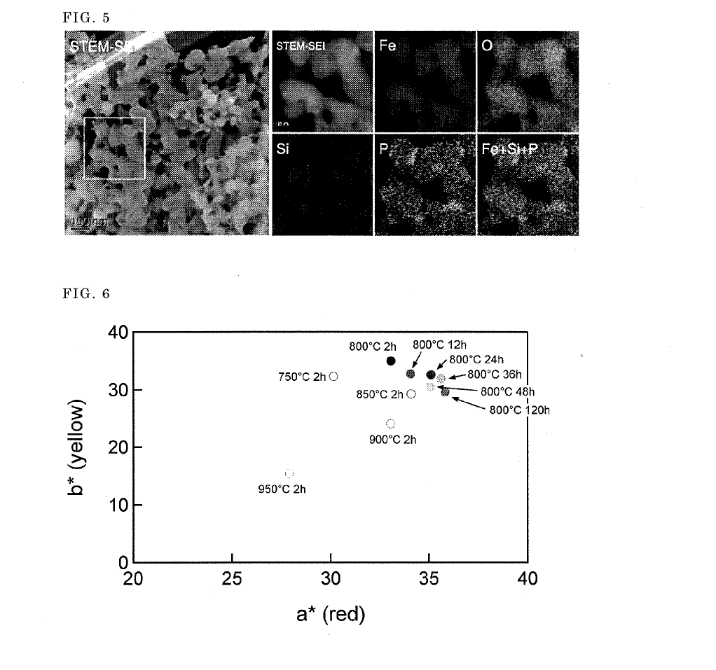

TEM observations were performed to study in detail the reason for L-800's beautiful color (FIG. 4). The results showed that L-BIOX was tubular, and its electron diffraction pattern showed a halo pattern (FIG. 4a). L-800 particles maintained their tubular shape even after exposure to high temperature, and the electron diffraction pattern of one tube showed a ring pattern (which means a polycrystal assembled of crystal grains). Thus, the results clarified that one tube is an aggregate of hematite crystal grains. The diameter of L-BIOX shrank from 1.35 μm to 1.26 μm (shrinking ratio: 7%). TEM observations were performed to confirm the arrangement of ions and the microstructure (FIG. 4c and FIG. 4d). The observations showed that L-BIOX was amorphous and exhibited granular particle morphology, while L-800 crystallized to hematite with a diameter of about 40 nm, and that the hematite particles were covered with an amorphous phase (FIG. 4d). The morphologies and sizes of these crystals and the amorphous phase were heterogeneous. The amorphous phase was subjected to EDS point analysis, and Si and O were mainly detected. This suggests that the amorphous phase is an amorphous silicate. As shown in FIG. 5, the elemental mapping results obtained using EDS (“JED-2300T,” produced by JEOL) associated with a scanning transmission electron microscope (STEM; “JEM-2100F,” produced by JEOL) also confirmed that many Si and P existed around iron.

Thus, the present inventors confirmed for the first time an interesting phenomenon that when subjected to heat-treatment, amorphous iron oxide L-BIOX separates into two phases: hematite and silicate. As a result, it was revealed that the obtained hematite had a nanostructure with a small particle size, which was covered with a silicate. It is known that hematite with a small particle diameter has a vivid red color [6, 7], and that silica-coating of hematite enhances its color [8, 9]. Accordingly, improved color of the sample is surely attributable to small particle diameter (40 nm) and presence of a silicate shell. Furthermore, a tubular structure also seems to contribute to improved color, because the structure inhibits the aggregation of individual hematite particles, as well as the aggregation of tubes. In fact, the present inventors confirmed that when the sample was crushed with an alumina mortar to break the tubes, the values of L*, a*, and b* were lowered.

The phase separation phenomenon of L-BIOX by heat treatment is considered as follows. The present inventors' previous research revealed that L-BIOX has chemical bonds of Fe—O—Si and Fe—O—P. First, thermal energy is used to break these bonds. Secondly, thermal energy is used to rearrange the ions and nucleate the hematite crystals, resulting in a phase separation into the two phases of hematite and amorphous silicate. Finally, thermal energy is used to cause hematite grain growth. Phosphorus is known to promote phase separation of glass [10], which suggests that the observed phase-separation process is also promoted by phosphorus.

Thus, the present inventors investigated how the color changes according to the heat treatment temperature and heat treatment time. As observed by the naked eye, the samples were red when heated at 750° C. or higher. Accordingly, the samples were heat-treated in atmospheric air for 2 hours at 750° C. to 950° C., in increasing increments of 50° C., and measured for their color. Additionally, how the color changes by varying the heating time from 12, 24, 36, 48, to 120 hours while fixing the temperature at 800° C. was also investigated. FIG. 6 and Table 1 show the results. At 750° C., both a* and b* were more than 30, which are large values. At 800° C., both a* and b* increased greatly. At 850° C., a* slightly increased, whereas b* decreased. At 900° C. or higher, both a* and b* greatly decreased. The naked eye observation and color measurement results taken together indicate that when heated at a temperature of 750 to 900° C., the powders had a vivid red color. Compared to the sample heat-treated at 800° C. for 2 hours, the samples heated at 800° C. for different periods of time had slightly decreased b* and greatly increased a*. Thus, powders of any color with an a* of 30 to 36 and a b* of 24 to 35 could be produced by controlling the heating temperature and time.

TABLE 1
Color measurements of L-BIOX-1 samples heat-treated at various
temperatures or for various periods of time (L*, a*, b* values)

| | L* | a* | b* |
|---|---|---|---|
| Heating temperature | | | |
| 750 | 47.3 | 30.1 | 32.3 |
| 800 | 48.6 | 33.1 | 35.0 |
| 850 | 45.5 | 34.1 | 29.2 |
| 900 | 42.6 | 33.1 | 24.1 |
| 950 | 35.7 | 27.9 | 15.4 |
| Heating time | | | |
| 2 | 48.6 | 33.1 | 35.0 |
| 12 | 46.6 | 34.1 | 32.8 |
| 24 | 45.8 | 35.1 | 32.6 |
| 36 | 45.7 | 35.6 | 31.9 |
| 48 | 45.0 | 35.1 | 30.4 |
| 120 | 44.3 | 35.8 | 29.6 |

FIG. 7 shows the STEM-EDS mapping results of the samples heat-treated at 750° C. to 950° C. Secondary electron STEM images are shown in the top row, whereas overlapping Fe and Si mapping images are shown in the bottom row. The results show that in all of the samples, Si was present around Fe, thus indicating that a composite of hematite and silicate formed a tubular structure. The results further show that as the heat treatment temperature increased, the particle diameter of hematite increased, and silicates coalesced into an aggregate with an increased area. When the samples were heat-treated at a constant temperature of 800° C. for various periods of time, the particles grew large for 48 hours, and the particle growth was saturated when heated for a period of 48 hours or longer. The elemental mapping images clearly indicate that all of the samples were composites of hematite and silicate.

When L-BIOX-1 was heat-treated at 750 to 900° C., a vivid color powder could be produced. The analysis results clearly indicate that this powder maintained a tubular structure of iron oxide derived from iron-oxidizing bacteria, and was composed of a composite of amorphous silicate and hematite particles with a diameter of several tens to several hundreds of nanometers.

### [Assessment of Heat-Treated L-BIOX-2 Sample]

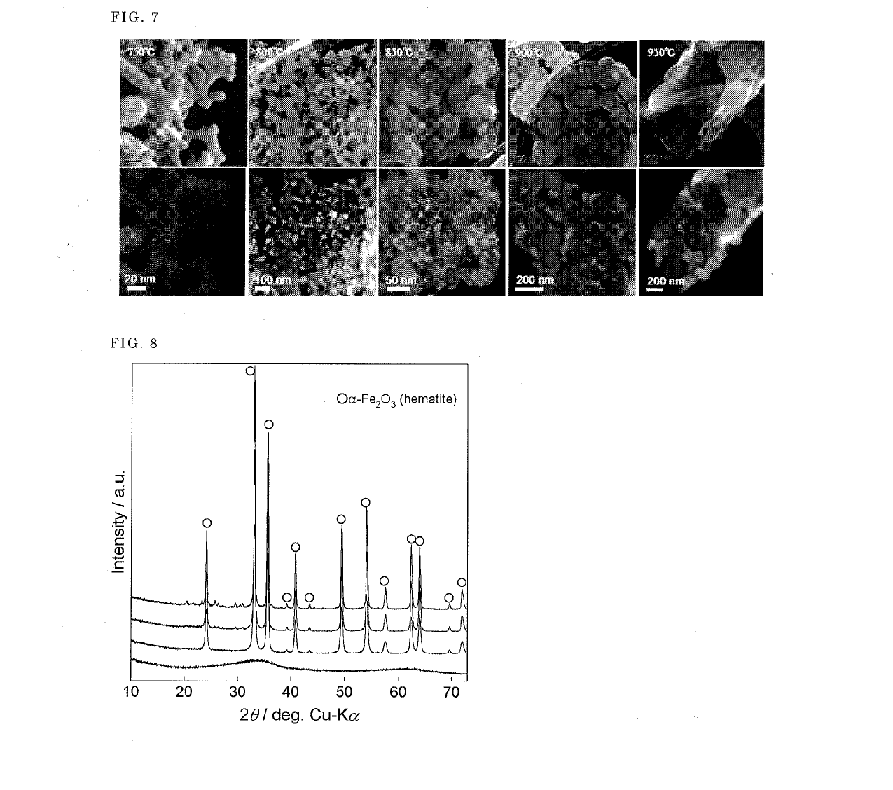

FIG. 8 shows XRD patterns of the heat-treated L-BIOX-2 samples. At 750 and 800° C., a single phase of hematite was observed. At 850° C., many small peaks were observed in the 20 to 30° background, thus suggesting that a certain component in L-BIOX-2 was crystallized. Compared to normal iron hydroxide, L-BIOX-2 has a high transformation temperature to hematite, which is a common characteristic with L-BIOX-1.

As observed by the naked eye, all of the samples had a vivid red color. However, compared to the L-BIOX-1 sample heat-treated at the same temperature, the L-BIOX-2 sample had a slightly inferior color. FIG. 9 and Table 2 show the color measurement results. At 700° C., both a* and b* were 30 or more, and a vivid color was achieved. As the heat treatment temperature was increased, no substantial change was observed in b*, and there was a sharp increase in a* up to 850° C. At 900° C. or higher, a* and b* greatly decreased. The naked eye observation and color measurement results taken together indicate that vivid red powders were obtained when heated at 700 to 900° C.

TABLE 2
Color measurements of L-BIOX-2 samples heat-treated
at various temperatures (L*, a*, b* values)

| Heating temperature | L* | a* | B* |
|---|---|---|---|
| 700 | 43.8 | 31.4 | 30.1 |
| 750 | 44.5 | 32.0 | 30.1 |
| 800 | 44.2 | 33.8 | 29.7 |
| 850 | 41.4 | 34.9 | 27.1 |
| 900 | 40.0 | 32.6 | 22.7 |
| 950 | 36.6 | 28.1 | 17.2 |

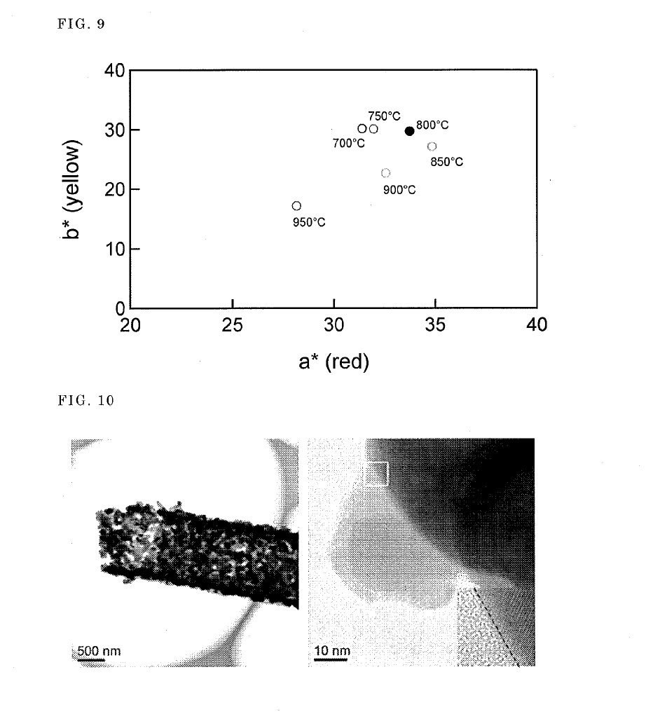

FIG. 10 shows a TEM image of the L-BIOX-2 sample heat-treated at 800° C., which had high a* and b*. Compared to the unheated sample, the L-BIOX-2 sample heat-treated at 800° C. had a slightly shrunk tube diameter, but maintained its tubular shape. Compared to the L-BIOX-1 sample heat-treated at 800° C., the L-BIOX-2 sample had large hematite particles. The magnified images of the heat-treated L-BIOX-2 sample indicate that unlike the L-BIOX-1 sample heat-treated at 800° C., an amorphous phase was not present in such a way as to coat the particles, but was present in the vicinity of hematite particles. Most of the amorphous phase adhered to a portion of the particles, or was present between the hematite particles. Similar to the L-BIOX-1 heat-treated sample, this specific microstructure seems to contribute to improved color.

### [Assessment of Heat-Treated G-BIOX Sample]

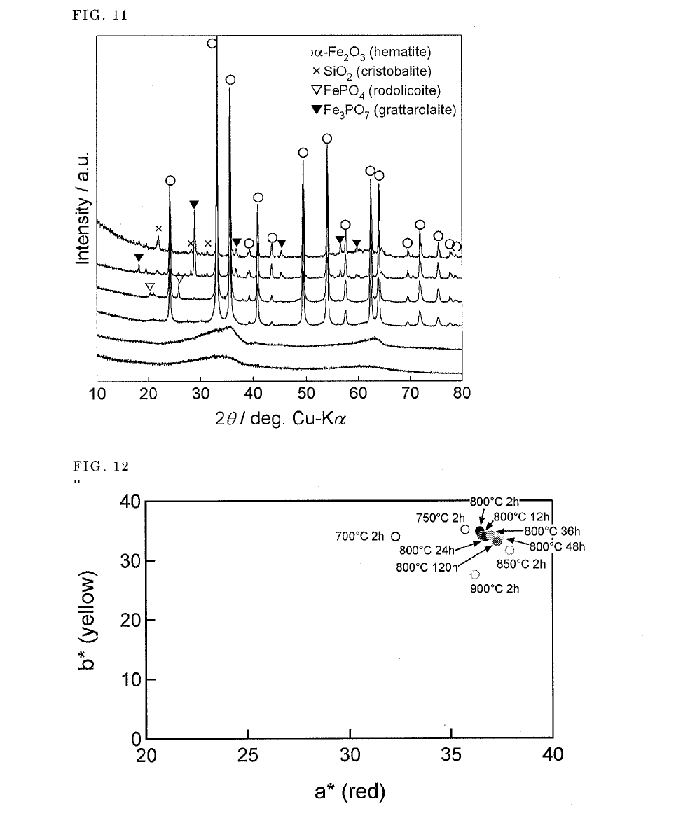

FIG. 11 shows XRD patterns of the heat-treated G-BIOX samples. At 600° C., two broad peaks became slightly sharp; at 700° C., a single phase of hematite was observed. At 800° C. or higher, crystalline iron phosphate and silicon dioxide were also produced. In the G-BIOX heat-treated at 900° C., many small peaks were observed in the 20 to 30° background, similar to the case of the L-BIOX-2 sample heat-treated at 850° C. Compared to normal iron hydroxide, G-BIOX had a high transformation temperature to hematite, which is a common characteristic with L-BIOX-1 and L-BIOX-2.

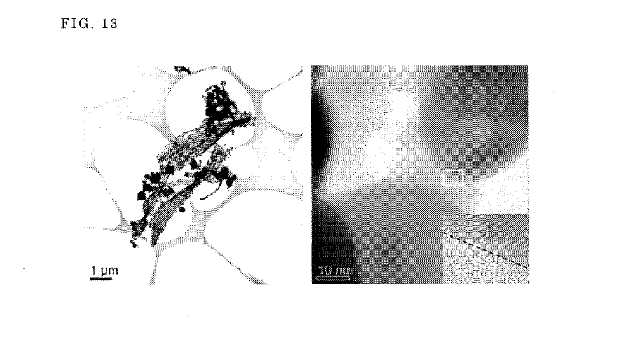

All of the heat-treated samples had a vivid red color as observed by the naked eye. Among the three types of samples used as starting materials in this experiment, the G-BIOX samples achieved the highest a* and b* values. FIG. 12 and Table 3 show the color measurement results. The G-BIOX sample heat-treated at 700° C. had an a* of about 33 and a b* of about 35, both of which are high values. When the temperature of the heat treatment was increased, a* and b* increased up to 800° C. At 850° C., a* increased greatly, whereas b* decreased slightly. At 900° C., both a* and b* decreased, but a* was still a large value of about 37. The naked eye observation and color measurement results clearly indicate that heat-treated samples using G-BIOX as the starting material had the best red color. The tendency of changes in a* and b* values according to the heat treatment temperature and heating time was similar to that of the heat-treated L-BIOX-1 sample.

TABLE 3
Color measurements of G-BIOX samples heat-
treated at various temperatures or for various
periods of time (L*, a*, b* values)

| | L* | a* | b* |
|---|---|---|---|
| Heating temperature | | | |
| 700 | 42.7 | 32.3 | 34.0 |
| 750 | 43.8 | 35.7 | 35.1 |
| 800 | 44.0 | 36.5 | 34.8 |
| 850 | 41.6 | 37.9 | 31.6 |
| 900 | 39.6 | 36.2 | 27.5 |
| Heating time | | | |
| 2 | 44.0 | 36.5 | 34.8 |
| 12 | 43.4 | 36.6 | 34.1 |
| 24 | 43.5 | 36.7 | 34.0 |
| 36 | 43.4 | 37.0 | 34.1 |
| 48 | 43.0 | 37.4 | 33.7 |
| 120 | 42.6 | 37.3 | 33.1 |

FIG. 13 shows a TEM image of the G-BIOX sample heat-treated at 800° C., which had high a* and high b*. Although the entire length was shortened, the G-BIOX sample maintained its helical shape even after the heat treatment. The particle diameter of hematite in the G-BIOX sample heat-treated at 800° C. was similar to that in the L-BIOX-1 sample heat-treated at 800° C. A magnified image of the heat-treated G-BIOX sample indicated that, similar to the L-BIOX-2 sample, an amorphous phase was present within the vicinity of hematite particles, and that most of the amorphous phase adhered to a portion of the particles or was present between the hematite particles. The way that the amorphous phase is formed is considered to depend on the size of the hematite crystal particles produced, and the Si and P contents of the unheated sample. Specifically, when hematite particles are small and Si and P contents are high, an amorphous phase is formed in such a way as to coat the hematite particles (for example, the L-BIOX-1 sample heat-treated at 800° C.). In contrast, when hematite particles are large and Si and P contents are low, an amorphous phase is considered to be formed in such a way that the amorphous phase adheres to a portion of the particles or interlocks the hematite particles (for example, the L-BIOX-1 sample heat-treated at 900° C. and the L-BIOX-2 sample heat-treated at 800° C.). Similar to the heat-treated L-BIOX-1 sample, this specific microstructure seems to contribute to improved color. It is presently unknown how the difference between helical and tubular shapes causes color changes.

### REFERENCES

[1] H. Hashimoto, S. Yokoyama, H. Asaoka, Y. Kusano, Y. Ikeda, M. Seno, J. Takada, T. Fujii, M. Nakanishi, R. Murakami, J. Magn. Magn. Mater., 310 (2007) 2405-2407.
[2] T. Suzuki, H. Hashimoto, H. Ishihara, T. Kasai, H. Kunoh, J. Takada, Appl. Environ. Microbiol., 77 (2011) 7873-7875.
[3] T. Suzuki, H. Hashimoto, A. Itadani, N. Matsumoto, H. Kunoh, J. Takada, Applied and environmental microbiology, 78 (2012) 236-241.
[4] A. Campbell, U. Schwertmann, H. Stanjek, J. Friedl, A. Kyek, P. Campbell, Langmuir, 18 (2002) 7804-7809.
[5] N. Galvez, V. Barron, J. Torrent, Clays Clay Miner., 47 (1999) 375-385.
[6] T. Takada, J. Jpn. Soc. Powder Powder Metall., 4 (1958) 160-168.
[7] Y. Kusano, M. Fukuhara, J. Takada, A. Doi, Y. Ikeda, M. Takano, Acc. Chem. Res., 43 (2010) 906-915.
[8] F. Bondioli, A. M. Ferrari, C. Leonelli, T. Manfredini, Mater. Res. Bull., 33 (1998) 723-729.
[9] Y. Zhang, P. Rao, M. LU, D. Zeng, J. Wu, J. Am. Ceram. Soc., 92 (2009) 1877-1880.
[10] E. M. Rabinovich, M. Ish-Shalom, A. Kisilev, J. Mater. Sci., (1980) 2027-2038.

1. A hematite composite formed by aggregation of fine particles, each of the fine particles comprising a crystalline hematite particle and phosphorus-containing amorphous silicate covering the crystalline hematite particle.

2. The hematite composite according to claim 1, which is hollow or helical.

3. The hematite composite according to claim 1, wherein the crystalline hematite particle contains silicon and phosphorus.

4. The hematite composite according to claim 3, wherein the content (atomic ratio) of silicon and phosphorus in the crystalline hematite particle is less than the content (atomic ratio) of silicon and phosphorus in the amorphous silicate.

5. The hematite composite according to claim 1, which has a red color value a* (reddish) of 25 or more.

6. The hematite composite according to claim 1, which has a yellow color value b* (yellowish) of 30 or more.

7. A pigment comprising the hematite composite according to claim 1.

8. The pigment according to claim 7, which is for use in ceramics, paints for art, coatings, inks, or cosmetics.

9. A cosmetic composition comprising a cosmetic pigment containing the hematite composite according to claim 1 and a cosmetic base.

10. A method for producing the hematite composite according to claim 1, comprising the step of heat-treating an amorphous and/or microcrystalline iron oxide containing silicon and phosphorus.

11. The method according to claim 10, wherein the heat treatment is conducted at a temperature of 700 to 1000° C.

12. The method according to claim 10, wherein the heat treatment is conducted at a temperature of 750 to 900° C.

13. The method according to claim 10, wherein the iron oxide contains iron and oxygen as main components, and the element ratio of iron, silicon, and phosphorus, excluding oxygen, is 66 to 87:2 to 27:1 to 32, in terms of atomic %, the atomic % of iron, silicon and phosphorus summing up to 100.

14. The method according to claim 10, wherein the iron oxide contains 0.1 to 5 weight % of carbon.

15. The method according to claim 10, wherein the microcrystalline iron oxide is ferrihydrite and/or lepidocrocite.

16. The method according to claim 10, wherein the iron oxide is an iron oxide produced by an iron-oxidizing bacterium.

17. The method according to claim 10, wherein the iron oxide is an iron oxide separated from aggregated precipitates produced in a water purification method by iron bacteria.

18. The method according to claim 16, wherein the iron-oxidizing bacterium belongs to the genus Leptothrix and/or the genus Gallionella.

19. The method according to claim 16, wherein the iron-oxidizing bacterium is Leptothrix cholodnii OUMS1 (NITE BP-860).

20. The method according to claim 10, wherein the iron oxide is microcrystalline.
